(19) United States
(12) Patent Application Publication
(10) Pub. No.: US 2022/0245586 A1
(43) Pub. Date: Aug. 4, 2022

(54) Efficient Method for Delivery of Goods Using a Complex Network of Carriers

(71) Applicants: Amir Moghadam, San Jose, CA (US); Mahdis Shayan, San Jose, CA (US)

(72) Inventors: Amir Moghadam, San Jose, CA (US); Mahdis Shayan, San Jose, CA (US)

(21) Appl. No.: 17/649,373

(22) Filed: Jan. 31, 2022

Related U.S. Application Data
(60) Provisional application No. 63/143,861, filed on Jan. 31, 2021.

(51) Int. Cl. G06Q 10/08; G06N 5/02

(52) U.S. Cl. CPC G06Q 10/08355; G06N 5/02

(57) ABSTRACT

A method of parcel delivery from one or more sources to one or more destinations are in part or in complete fulfilled by multiple carriers, through exchanging one to all of the parcels at varying locations communicated to them by a decision making system which could update the locations of exchanges in real time or in periods not longer than one hour, or by dropping off zero, one, or multiple of the parcels and picking up zero, one or multiple other parcels at locations communicated to them by the decision making system. The time and/or location of the exchange, actions, directions, and/or the path of the participants is determined, updated, and communicated to the participants in real time or in intervals of at most one hour, or every time new information is received by the decision making system.

### RELATED APPLICATIONS

This application claims priority under 35 U.S.C. § 119(e) of U.S. Provisional Patent Application Ser. No. 63/143,861 filed on Jan. 31, 2021 and titled An efficient method for delivery of goods using a complex network of carriers. The content of this application is incorporated herein by reference.

### FIELD OF THE INVENTION

The present invention is in the field of real time or scheduled delivery of goods.

### BACKGROUND OF THE INVENTION

The advances in availability of network and wireless devices has led to development of independent contractor delivery systems. Currently all delivery networks rely on the nearby network of customers and near by network of providers in geographic areas to connect the supply and the demand. These delivery systems use the location of the consumer and the location of the provider in order to determine whether they would allow a costumer to order an item from a specific provider or not depending on their thresholds for the maximum distance they allow for a delivery.

One logical reason why all delivery systems only allow up to a certain distance for their delivery is the extreme cost for performing the long distance delivery. Also, even if the cost was not an issue, the fact that each of the carriers would have to drive for an extended amount of time, blocks their delivery resource for that extended amount of time which would lead to shortage of resources for performing their short distance deliveries.

Besides these challenges regarding the time and cost of the delivery, if the goods that are being delivered are perishable, it makes it even more challenging to perform long distance deliveries.

As a result of all these challenges and complexities, all delivery systems decide to perform the deliveries using one individual carrier that takes the goods from one or more providers to one or more consumers.

The subject of this patent is an innovation that overcomes the challenges associated with complex deliveries, minimizes the cost, time, distance or burden, or maximizes the variety, convenience and the coverage and expands the choices for the customers and facilitates performance of a complex fully and simultaneously optimized delivery.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

Disclosed here are the various mechanisms and processes, optimizing the timing and paths of a group of carriers, each carrying zero, one or multitude of deliverable goods picked up at different locations in a way that might involve dropping of each of their goods at one or multitude of locations other than the destination, to be picked up by a second carrier carrying zero, one or multitude of deliverable goods. Where after the pickup, the second carrier could either drop off the one or more of the goods at a second location that could be the destination or could be a second drop off location other than the destination. If the second drop off location is not the destination, a third carrier who is already carrying zero, one or multitude of deliverable goods can pick up the package one more time and drop it off at the destination or at another location other than the destination. This process will continue until the final drop of location other than the destination is within a reasonable range for a last carrier to pick it up and deliver the package to its final destination. The intermediate drop off locations can be physical locations, or any mobile location, or a physical or virtual rendezvous location for a group of two or more carriers indicated by unique signals generated by devices that are supposed to facilitate the process of finding the location where an exchange or other transactions should take place.

The process and mechanisms disclosed here include jointly scheduling and or optimizing multiple delivery orders that are to be fulfilled by multiple carriers and are to be picked up from a single or multiple locations which are to be delivered to either single or multiple different locations in a way that the delivery of each of the items from the source to the destination involves multiple carriers exchanging packages or items with each other in person (peer to peer) at assigned locations or while in motion, and/or by an intermediary exchange person stationary at an assigned location, or while moving towards a specific destination or exchange location where the coordination of the actions taken by each of the persons or devices involved in the delivery is performed a computing device that optimizes the timing and location of actions to achieve a desired outcome.

The methods described herein can be used to optimize the deliveries to make those deliveries more efficient and or more cost effective and/or more convenient for the customers and/or for the carriers and/or for the providers and/or to increase the variety of the ordering options for the customers or to minimize the loss or cancelation rate of orders in case of a surge of orders.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic representation of current distribution methods of deliveries.

FIG. 2 is a schematic representation of a delivery method according to an embodiment of the invention

FIG. 3 is a schematic representation of another delivery method according to an embodiment of the invention.

FIG. 4 is a perspective view of a smart packaging apparatus and signal-emitting attachable circuits and stands according to an embodiment of the invention.

FIG. 5 is a perspective view of a smart packaging apparatus comprising an exchange indicator signal device and terminal communication device according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention. In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a

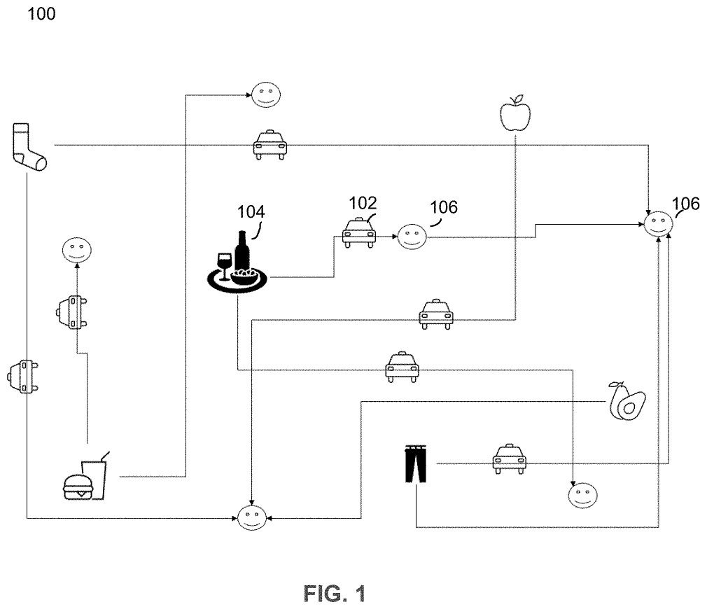

In one example scenario, as shown in FIG. 1, multiple delivery orders are received by the delivery system, some of which could be real-time and some of which could have been scheduled ahead of time.

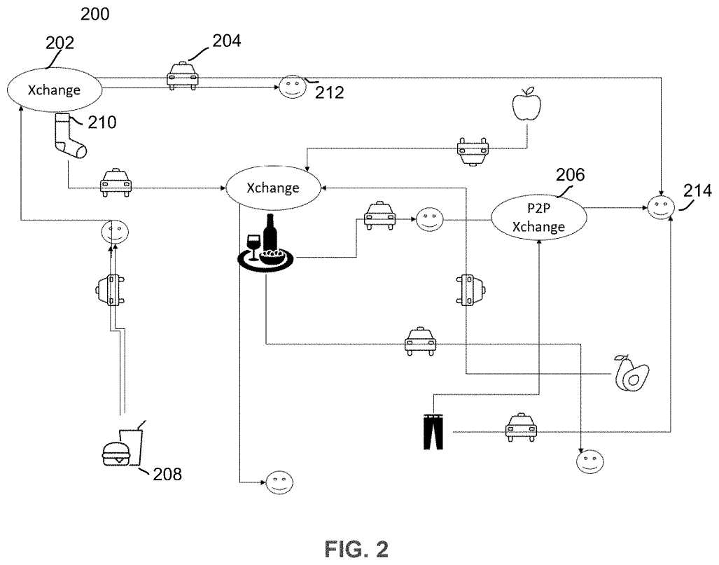

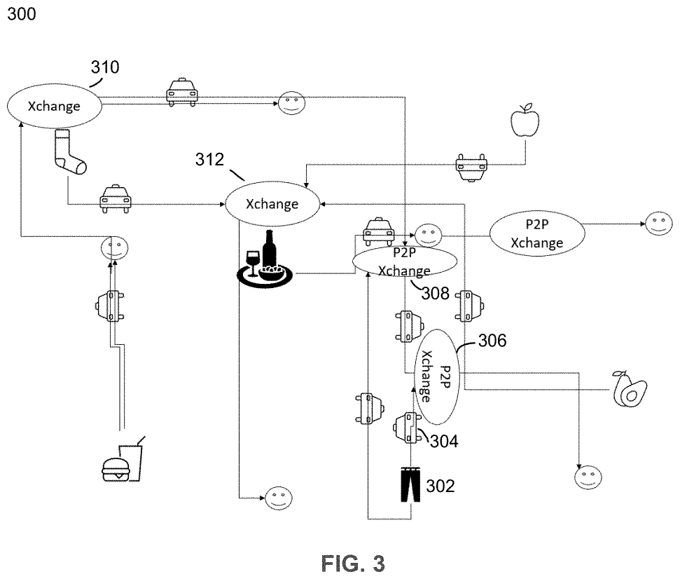

Referring now to FIGS. 2 and 3, alternative methods 200, 300 of delivering multiple parcels according to embodiments of the invention are presented. The location of the carriers 204 which is known by some means, including but not limited to GPS, cellular data location, etc, is normally used to optimize the cost and time of delivery. Normally in the currently used methods of delivery 100, each carrier 102 either picks up one or multitude of items 104 from a provider or multitude of nearby providers and then drops them off at a single or multiple customer locations 106. Therefore, the delivery of the goods from the source to the destination is completed by a single carrier 102. However, the innovation disclosed here will optimize the path of all available drivers in a way that they can perform package exchange, either directly (pear to pear sharing) 206, or by dropping the packages at a package exchange location 202 (exchange station, exchange vehicles, or exchange drones). By performing the package exchange 202 which is determined by the jointly optimizing algorithm, packages that were coming from different locations 208 & 210 that had to be taken to the locations that are grouped closely 212 & 214, or are desired to be taken by a single driver due to different criteria in the optimization, can all be transferred to the same driver 204 to be delivered to either the final destination of the package, or to another exchange location (peer to peer 206, exchange station, exchange vehicles, or exchange drones 202), or a combination of all.

In some embodiment, the algorithm can allow some carrier to take multiple packages from a single provider 302 or multitude of providers and exchange the packages once 306, twice 308, three times 310, or multiple times as determined by the algorithm through peer to peer exchange 306 & 308 or exchange at an exchange station to optimize the pickup time for the whole group of drivers.

In some embodiments, the exchange stations can be the providers 310, can be dedicated physical stations 312 which could be mobile, hovering, or stationary, or could be other carriers stationary at a certain location as determined by the algorithm or could be a single or multitude of human beings (including the carriers) or animals guarding the packages or just a physical location secured by robots or security cameras, or by physical or digital lock boxes or any other means, such as barriers or traps, + that could guarantee the safety of the package until the next carrier arrive to perform the next exchange.

In some embodiments, the exchange 202 could happen to prevent a carrier 204 from driving an extended distance resulting in an extensive delivery charge.

In some embodiments, the exchange could happen while the carrier or carriers and/or the exchange location are in motion at some part during the exchange.

The carriers could be humans on foot, or on any transportation device, automated delivery robots, self-driving cars, drones, boats, ships, trains, animals or any other means of transporting goods whether autonomous or operated by humans or a combination of these options.

In some occurrences, a single delivery might be fulfilled by a single carrier.

The optimization algorithm can use at least the location of each of the carriers and/or the location and/or time of readiness of all orders, and/or the location and time of the desired deliveries to determine the time of carrier dispatch, the location or locations that each driver should visit to pick up the new packages or drop off the previously acquired packages, and the path that each carrier should take to drop of the one or multiple packages that are in their custody to either an exchange location (peer to peer or exchange stations) or to their final destination. Additionally, the optimization algorithm could use probability distribution functions for the potential time and location of future orders and the location and or desired time of customers for delivery.

In some embodiment, the optimization algorithm can use historical data, or trained artificial intelligence and/or network activity of the ordering system as well to make decisions about the time and/or location of order processing and to determine which driver should move to what location to perform what action and for each exchange station to move to what location for the deliveries to get completed by a coordinated group of drivers to achieve the desired optimized outcome.

Additionally, various other pieces of information including but not limited to traffic data, historic delivery data of each carrier, capacity of order that can be handled by each carrier, capacity of exchange stations. Desirability of locations for peer to peer exchange or positioning or the location of exchange stations as well as preferences of the driver, level of perishability of the package, desired delivery speed can be used additionally as parameters in the optimization process.

In some embodiment one or multiple pieces of information can be provided by third parties using any method of data transfer or APIs.

In some embodiment, the algorithm could use multitude of network of carriers or third parties to achieve part of the delivery.

Additionally, the optimization algorithm can adjust the time of processing the orders by the providers to enhance and optimize the freshness of the goods to minimize the amount of time duration between the preparation of the item to the drop off at the exchange locations or at the final destination.

In one embodiment, optimization algorithm can target minimizing, maximizing or optimizing a single parameter or combination of parameters at least one of which could be, the cost of individual deliveries, cost of combination of any subsets of the deliveries, cost of combination of all deliveries, duration of individual deliveries, duration of combination of any subsets of the deliveries, duration of combination of all deliveries, travel distance of individual deliveries, travel distance of combination of any subsets of the deliveries, travel distance of combination of all deliveries, pickup convenience of individual deliveries, pickup convenience of combination of any subsets of the deliveries, pickup convenience of combination of all deliveries, processing convenience of individual deliveries, processing convenience of combination of any subsets of the deliveries, processing convenience of combination of all deliveries, increasing diversity of options of individual deliveries, increasing diversity of options of combination of any subsets of the deliveries, increasing diversity of options of combination of all deliveries.

In some embodiments, the optimization algorithm can optimize any of the criteria mentioned above individually or in any combination, including all combined, directly or indirectly through complex or simple mathematical functions for individual deliveries, subset of deliveries, or all deliveries combined.

In some embodiments, the algorithm may decide to modify the course of at least one or at most all delivery actions that are being carried out at any moment according to the change in the inputs, or the desired outputs of the optimization algorithm. For example if carrier A was on their way to destination A, at any moment they can be notified to drop off their package at a point B or do an exchange at a point C instead, and take a series of completely different actions as decided by the new outcome of the algorithm. As a result, as opposed to current state of the art delivery systems, any driver will still be part of the optimization as an available resource even though they are already carrying multiple items or packages which leads to higher efficiency of the delivery system.

It is understood that any function that is capable of calculating, evaluating or estimating any of the optimization parameters above can be used inside the optimization algorithm to create the same effect.

It is understood that any architecture of Artificial Intelligence or machine learning algorithms, including but not limited to Artificial Neural networks, Convolutional Neural networks, Deep learning algorithms, could be trained to optimize the delivery path of the combination of carriers to create the same effect as the mentioned optimization algorithm and should be considered protected by this disclosure, since the subject of this disclosure is not the mathematical method of optimizing, which can be achieved in infinite number of ways. The subject of this disclosure is the process of coordinating multiple carriers simultaneously to perform multiple deliveries, any or many of which are fulfilled by a combination of the carriers and not individual carriers which is the current standard. Therefore, using any different mathematical functions or a machine learning, artificial intelligence, stochastic methods or any other method of solving the multi carrier problem should be considered protected by this invention disclosure.

In some embodiments, optimization process can happen on a single or multitude of personal computers, any electronic device capable of performing mathematical operations, dedicated servers running the algorithm on any type of processing unit including, but not limited to CPU, GPU, FPGA, Microcontrollers, or on customer computer or other electronic devices, or on provider's computing devices, or any third party computers, servers or electronic devices that are capable of performing mathematical calculations, or any distributed computing network.

In some embodiment of this invention the optimization process can be either a joint optimization or a group of two or more optimizations ran iteratively to optimizer the desired aspect of the interconnected delivery network.

In some embodiments the optimization algorithm can use any of the well-known optimization methods individually or in combination, including but not limited to, Monte Carlo, Numeric optimization algorithms, Alpha-Betta Pruning, Branch and Beyond, Bruss algorithm, Chain Matrix multiplication, combinatorial optimization, Constraint satisfaction, cross-entropy method, Differential evolution, Dynamic Programming, Ellipsoid Method, Evolutionary computation, golden section search, Gradient Decent, Harmony search, Interior point method, Linear programming, Line search, Local search, Minimax, Nearest Neighbor search, Newton's Method, Non-Linear optimization, odds algorithm, simulated annealing, stochastic tunneling, subset sum algorithm, or any brute force optimization technique.

In some embodiments optimization process can run on a single CPU on a single thread, or can be multi-threaded, or can be distributed on many processor units, on a single computer or on a cluster, on one Graphical processor unit (GPU) or on multiple GPUS, or in a combination of CPU and GPU, or any other type processing units, running individually, or in a cluster, or in the cloud.

In some embodiment, blockchain could be used for the transfer and processing of order information between the customer, carriers, exchange locations in a distributed fashion.

The provider can be any locations, including but not limited to restaurants, grocery stores, warehouses, kitchens, other people, or any local provider of goods and/or services or any location or person that is not a registered provider, or any combination of all or a subset of all.

In some embodiments, the exchange station can be any or all provider locations, including but not limited to restaurants, grocery stores, warehouses, kitchens, or any local provider of goods and/or services any location or person that is not a registered provider, such as a house, or a storage location, or a piece of land or yard, street or ally curb side, anywhere a locker box, or car can be placed safely or on the water or in air or any combination of all or a subset of all.

In some other embodiments, the exchange location can be a delivery vehicle, boat or drone equipped or not equipped with organizing structure for keeping the goods in the desired condition.

In some embodiments the exchange location could perform pickup from the providers.

In some embodiments the exchange location could be a mobile provider.

The exchange station could be equipped with automated package exchange mechanisms, devices or robots.

The exchange location could have personnel and staff to carry out the exchange process manually or via the help or robots or other machinery, by taking the packages from the carriers hands or vehicle, and putting other packages in the carrier's hand or vehicle.

In some embodiment, the exchange station could perform the exchange while in motion.

In some embodiment the exchange station can be a vehicle with room for storage and means to detect the presence of other carriers supposed to perform an exchange at that location.

In some embodiments, the order processing units can decide to delay or expedite displaying the orders to be processed according to the decision determined by the optimization algorithm.

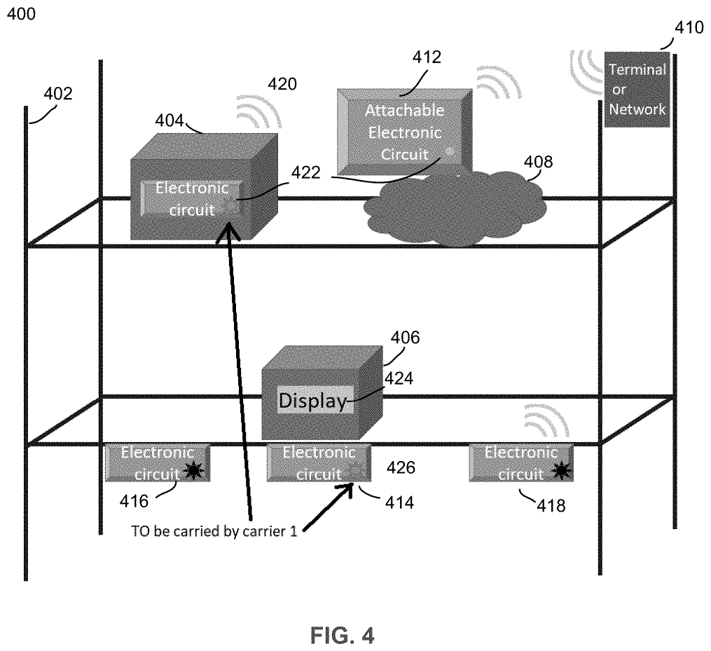

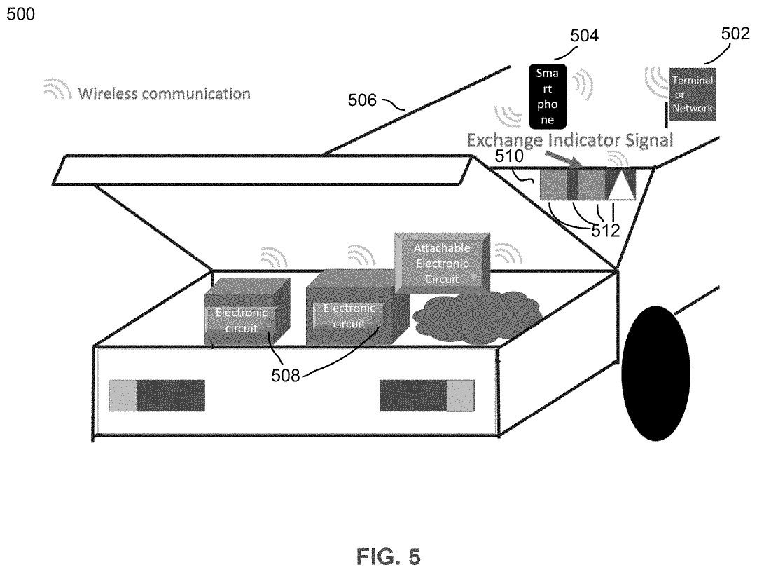

Referring now to FIGS. 4 and 5, smart packaging apparatuses according to embodiments of the invention are presented. In some implementation, the package containers 404, 406, 408 can have electronics circuits that can communicate either directly to the servers through networks 420 or with an intermediate electronic device or terminal 410 that can then connect them to a server or multitude of servers that transfer and communicate information between the customer, and/or carrier, and/or carrier's vehicle, and/or a third device in the carriers vehicle 502 and/or carried by the carrier 504 and/or the optimization algorithm, and/or the provider of the goods, and the package to inform different parts of the system about the status of the order, or could facilitate the transfer and exchange of the package.

In some other implementation the electronic circuit mentioned above can be an attachable device 412 that could be attached or detached from the goods and or their packaging or their covers or containers or the stands or the lockboxes.

In some other implementation the electronic circuit 414, 416, 418 mentioned above could be an integrated part of the stand 402, the lockbox, the carrier vehicle, or the exchange station facility or vehicle.

In some implementations, The packages 404, 406 can be smart, have wireless connectivity 420, lights 422, signs 424, or barcodes or a combination of all, that would facilitate identification of the package that is supposed to be picked by the carrier, or to be used by the provider.

In some implementations, the packages can have smart locks that could be actuated and deactivated through the servers, or directly by the carrier, provider, the vehicle, or the costumer.

The optimization Algorithm could also track the location of the packages, and optimize the distribution of the packages to ensure, there are available packaging at locations that are desired.

In some embodiments, the exchange location 400 and or carrier vehicles 506 can be equipped with electronic devices 418, 502, 504 that facilitate the exchange by displaying detailed instructions on which box/boxes 414, 422, 508 (emitting what signal), should be taken out, and where it should be placed 418 and which box/boxes (emitting what signal), should be transferred to the carrier 404, 406.

In some embodiments, the exchange facility and/or carrier vehicles can send signals via the central server or any of the distributed servers to the packages or the attachable electronic circuits, to make all that need to be exchanged to produce unique signals 418, 502 to the parties involved in the delivery to speed up and facilitate the exchange process by making the packages to be picked up, dropped off, or exchanged easily distinguishable by the signal that is being emitted from them.

In some embodiments, the carrier devices carried by the carriers 504, or located in their vehicle, can communicate to the smart packages or the attachable electronics, or with the electronics on or in the package stands 402 or containers, and trigger signaling by the boxes, so that the boxes generate new signals for the parties involved in the delivery to easily identify the packages and or the items that needs to be exchanged by, one, two or multiple carriers.

In some embodiments, the signal could be a certain color of light emitted by each box 422, where the light color that needs to be carried by any of the carriers can be displayed or communicated to the carrier on their communication device 504 which could be their personal phone, tablet, or the device installed inside their vehicle.

In another embodiment, a number, name, code, shape, barcode, sound, vibration or heat or lighting sequence, or sound sequence, or shape sequence, or a number sequence could be used in order to identify the boxes that each carrier needs to carry, or drop off or exchange.

In another embodiment, The carrier vehicle and/or the carrier and/or exchange location and/or the exchange personnel, and/or the provider location and/or the provider personnel can be equipped with a signaling system 510, that can produce a unique signal 512, including but not limited to lights, sounds shapes, patterns, codes, characters, colors, flashing patterns, or any combination of any of these with another detectable signaling method, that can communicate, through a terminal 502, or directly with the carrier's device 504, or the providers device, or the exchange station's device, or network through which it could receive a list of actions to take. One of which actions would be to create a unique signal 512 to indicate to the participants in the delivery the location where at least one of their transactions should take place, and the same unique signal can be also displayed on the carrier's or exchange personnel's, or the provider's device 504 for them to quickly identify the location where their next transactions of any kind should be carried out.

In some embodiment, the signaling device 510 could also act as the terminal 502 that communicates directly with the packaging circuitry.

In some implementation, the signaling device 502 could be detachable, mounted behind the rear glass of the vehicle 506, on the trunk, on top, or any other visible location on the vehicle, and/or exchange station, and/or the provider location and/or a destination and/or a package or item itself.

In some implementation, the devices of the carriers can notify the carriers about the occurrence of an exchange or other transaction based on the location of the exchange location or their peers or the location where a delivery transaction should take place and also notify them of the signal 512 that they should be looking for.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

1- A method of delivery of items from a single or multitude of sources to a single or multitude of destinations, where the deliveries are in part or in complete fulfilled by multiple carriers, through exchanging at least one and at most all of the items or parcels that they carry, at least once and at most thirty thousand times, at varying locations communicated to them by a decision making system which could update the locations of exchanges in real time or in periods not longer than 11 hours, or by dropping off zero, one, or multiple of the packages or items they carry and picking up zero, one or multiple other packages or items at locations communicated to them by the decision making system where the time and/or the location of the exchange and/or actions and/or directions and/or the path of the participants is determined and updated and communicated to the participants in real time or in intervals of at most 11 hours, or every time a new piece of information such as traffic information, location of carriers, location of items and destinations, or status of the items to be delivered is received by the decision making system.

2- The method of claim 1 where the exchanges can happen peer to peer by carriers at varying locations decided or updated and communicated to the participants by the decision making system.

3- The method of claim 1 where the instructions to the participants including path, destination, actions to take, parcels to pick up, locations of exchange, pickup or drop off and the person to exchange the package with, can change at any moment before, or during an action or even after they have completed their last instructed actions.

4- The method of claim 1 where the carriers, exchange personnel and providers and receivers cooperate with autonomous vehicles or robots as part of the delivery where the actions to be taken by the autonomous vehicles and robots are also communicated to such devices by the decision making system.

5- The method of claim 1 where the exchanges are performed to enhance the availability of items from the providers to the destinations that are at an extended distance, by transporting the items part by part, individually or in combination with other short distance or long distance deliveries, between multiple exchange locations in order to gradually bring the items to closer or to a more preferable location to be finally delivered to it's final destination in order to reduce the cost of the long distance deliveries.

6- The method of claim 1 where the mathematical calculations involve optimizations that are performed using any type of processing unit including central processing units, Graphical processing units, or distributed processing systems, to optimize at least one of the parameters such as the distance traveled and/or time of delivery and/or cost of delivery and or number of needed carriers or any combination of those factors for each or a combination of the packages or each or combination of the participants to a desired balance.

7- The method of claim 6 where the outcome of the optimization is at least a set of, carrier identifications, times, locations and paths, actions for each carrier, such as, exchanging packages and the relevant details and instructions regarding the exchange action such as carrier identifiers, and unique package identifiers, and other actions such as stopping, waiting, turning on a signal, or turning around in circles to pass time when parking space is not available, which will be communicated to the participating carriers and providers and receivers in order to accomplish the complex delivery of all items in a coordinated manner.

8- The method of claim 6 where the optimization process co-optimizes the distance traveled and/or time of delivery and/or cost of delivery, for a group of carriers and a group of customers at the same time to find the best delivery solution for the whole group.

9- The method of claim 6 where the outcome of the optimization is communicated to each of the carriers, providers and exchange locations and personnel and the customer using text messaging, Phone call, email, voice mail, pagers, wireless communication or via a mobile app, tablet or any electronic device capable of wireless communication and displaying audio or visual instructions.

10- A system of delivery where the packaging of the goods, or the stand or shelf or the container or lockbox where the items are located or placed, include one or more electronic circuitry which by means of sound, light, vibration. mechanical motion, heat, images, labels, or barcodes, or shapes, numbers, characters or a combination of any subset of these signals, displayed or emitted by any version of light or display or sound generating system, could facilitate the process of identifying, picking up, dropping off or exchanging the packages for the carrier or the provider or exchange staff by displaying to them on their own device or devices the details of the signal being emitted by the package, stand, shelf or container that they should be looking for and on which they have to perform an action.

11- The system of claim 10 where the hardware attached or embedded in the packaging could directly or indirectly connect to a communication or data transfer network and retrieve information about the actions that the package needs to take and the signals that it should generate, the actions being either generating one or more unique or non-unique signals detectable by the carrier or provider, or exchange personnel, locking or unlocking the package, or generating or transferring information regarding the status or location of the package.

12- The system of claim 10 where another electronic device acts as a terminal which communicates with packages, and transmits the information to another server or multiple servers, and this electronic device is installed either in the exchange locations, in the carrier cars, or carried by the carriers, or are located at provider locations.

13- The system of claim 10 where the electronics, or the signal generating part of the system or the whole signaling system is an attachable and detachable component which might or might not be equipped with an RF or magnetic or barcode identifier.

14- A method of exchanging delivery items and packages where the exchange locations can be mobile such as any means of transportation or drone capable of changing their location to a location determined by the decision making system, and performing the exchange while in motion or when static.

15- The method of claim 14 where the exchange can happen in motion either directly from one carrier to another, or between a carrier and a mobile exchange location.

16- The method of claim 14 where the exchange location could also perform the delivery or part of the transportation of some of the deliveries, or the final drop off for some of the deliveries.

17- The method of claim 6 where the timing of the communications and actions to be taken carried by all parties customer, provider, carrier and exchange personnel which is displayed to them on their devices are determined by a computer algorithm that could be executed on at least a single processor including CPU, GPU, FPGA, Microcontrollers or any other device capable of performing mathematical or logical operations, or a distributed network of processors by conventional programs or artificial intelligence or stochastic methods.

18- The method of claim 17 where the timing of the processing of the orders is also determined by the optimization algorithm and the timing is either left unchanged, is delayed or is expedited by the algorithm to improve at least one of the cost, distance traveled, time, availability, or the experience of the costumer or a combination of any subset of these parameters.

19- The method of claim 6 where historical data including at least historical traffic data or historical efficiency of each of the actions of each of the participants involved or ordering frequency history, probability distribution functions of the aforementioned data or stochastic methods are used as part of the decision making in the determination of the trajectory of carriers and timing of the actions taken by the parties involved in the delivery operation.

20- The method of claim 1 where the carriers and/or exchange stations and/or providers and/or carrier vehicles and/or delivery destinations are equipped with an exchange signal that can generate unique audio, vibration or visual signals that are also displayed on the carrier's device or the exchange station's personnel's device, based on the proximity of their locations that clearly indicates to the carrier, provider, or the exchange personnel that an exchange transaction should be carried out at the location indicated by the signal by them or for them.
